(19) United States
(12) Patent Application Publication
(10) Pub. No.: US 2006/0023236 A1
(43) Pub. Date: Feb. 2, 2006

(54) Method and arrangement for copying documents

(76) Inventors: Otto K. Sievert, Oceanside, CA (US); Dean Anderson, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/909,237

(22) Filed: Jul. 30, 2004

(51) Int. Cl. G06K 1/00

(52) U.S. Cl. 358/1.12; 358/2.1; 358/1.9

(57) ABSTRACT

A method for copying documents, includes creating input document image data for a plurality of input documents; analyzing and manipulating the image data based on collation feature criteria; and forming a coherent output document from the analyzed and manipulated image data.

### BACKGROUND OF THE INVENTION

The present invention relates generally to copying pages from a mixture of various documents and forming a new coherent output document using copier machines.

When copying document pages from the various different input documents into a new output document, the original document pages may already be numbered or they may, in some cases, be unnumbered. In addition, there may be intentionally blank pages included in the input pages as separator sheets. Under such circumstances, it will accordingly be difficult for the recipient to determine if the new output document is complete of if some page numbers are missing or, if present, are apt not be consecutive because of the varied origination of the input document pages. Indeed, this is made more confusing if the above mentioned blank pages are included in the new output document, in that it will not be immediately clear if blank pages are intentionally inserted, or if the pages in the input document did not all copy correctly.

As will be understood, it is time consuming to take an non-cohesive set of pages and copy them into a cohesive output document set. The manual solution of marking (re-numbering) output page numbers by hand incorporates all of the disadvantages mentioned above.

### BRIEF DESCRIPTION OF THE DRAWINGS

FIG. 1 is a flow chart which illustrates copying functions for implementing one embodiment of the present invention.

FIG. 2 is a block diagram which illustrates a copying system according to one embodiment of the present invention.

FIG. 3 is a block diagram depicting image analysis functions carried out on stored digital image data according to one embodiment of the present invention.

FIG. 4 is a flow chart illustrating a method for analyzing digital image data according to one embodiment of the present invention.

FIGS. 5A, 5B, and 5C show examples of a text orientation in a page according to one embodiment of the present invention.

FIG. 6 is a block diagram depicting image manipulation functions carried out on stored digital image data according to one embodiment of the present invention.

### DETAILED DESCRIPTION OF THE EMBODIMENTS

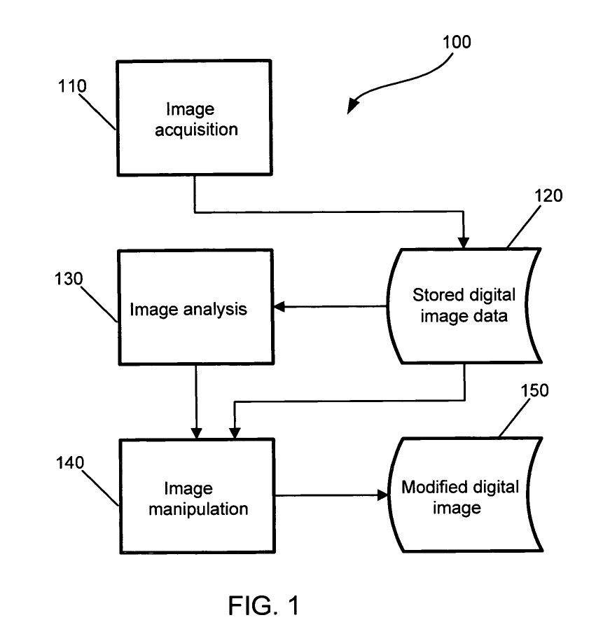

FIGS. 1, 2, 3, 4, 5A, 5B, 5C, and 6 are provided for illustration purposes only and are not intended to limit the present invention. Given the following disclosure one skilled in the art to which the present invention pertains or most closely pertains would recognize the various modifications and alternatives, all of which are considered to be a part of the present invention.

Referring to FIG. 1, there is shown a schematic flow diagram of an embodiment of a copying system 100, which illustrates the overall copying functions implemented thereby. According to this embodiment, input document image data of a plurality of different input documents is created in an image acquisition step 110. This input document image data is derived by scanning-in, digitizing and storing (step 120) each of the pages of the plurality of input documents.

The stored digital image data is then analyzed and manipulated in steps 130 and 140, respectively. This analysis and manipulation is based on collation feature criteria to be discussed below, and enables the output of a coherent output document in the form of modified digital image data at step 150. The term “coherent” in this context means an orderly, logical and consistent relation of the pages of a document.

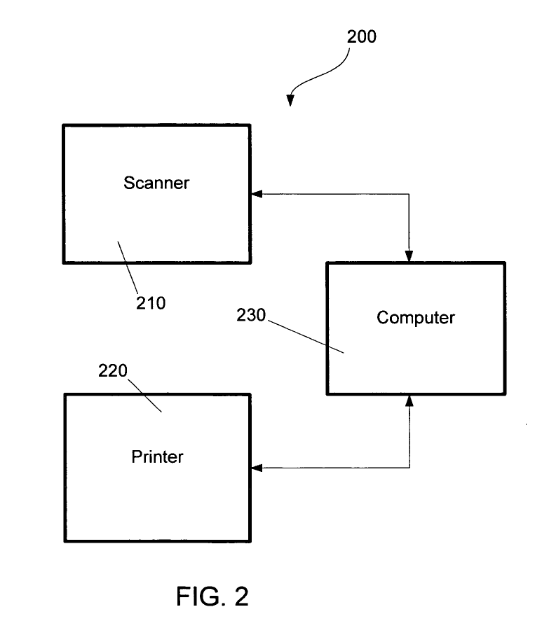

The copying functions as shown in FIG. 1, can also be implemented using a system 200 as illustrated in FIG. 2. The system 200 may comprise a scanner 210 and a printer 220 connected through one or more computers 230.

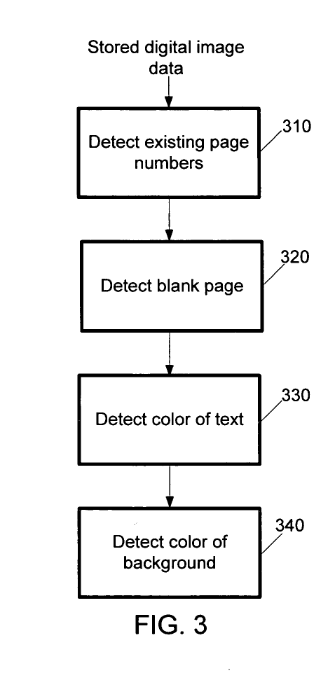

FIG. 3 illustrates, in block diagram form, the image analysis functions which are carried out on the stored digital image data (represented by block 130 in FIG. 1) based on collation feature criteria, according to an embodiment of the present invention. The criteria may include those necessary for detecting existing page numbers of the image at step 310, detecting a blank page in the image at step 320, detecting a color of text in the image at step 330, and detecting color of background in the image at step 340. It should be noted that the steps 310, 320, 330, and 340 are not necessarily executed in the same order as shown in FIG. 3. The following paragraphs will explain the method of performing the above mentioned image analysis functions based on collation feature criteria of the copying system 100.

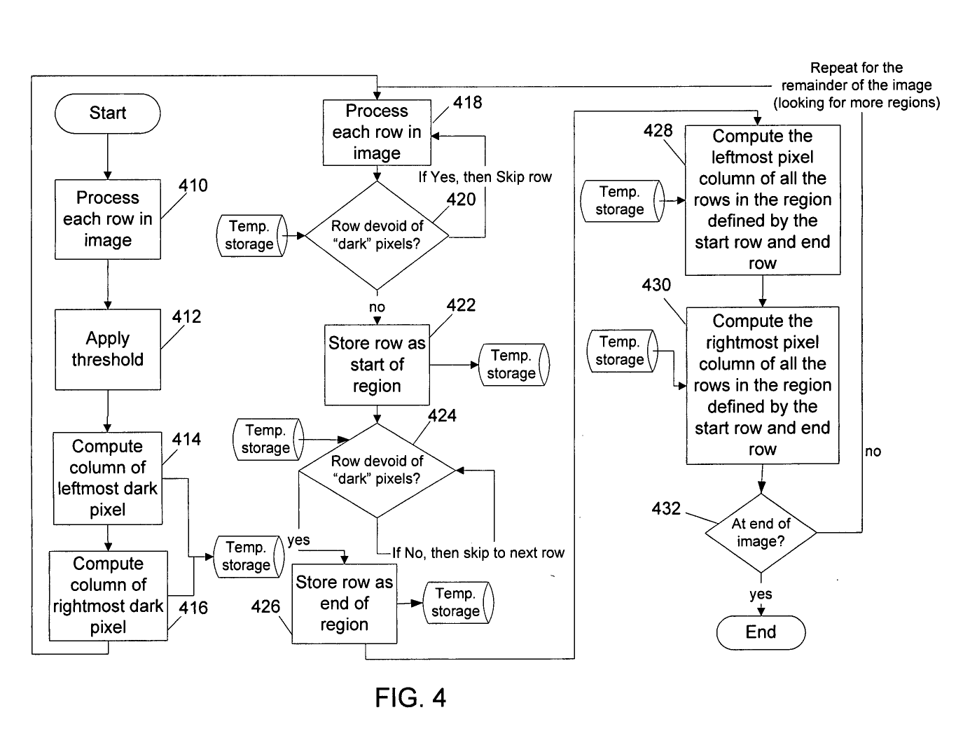

The step 310 of detecting existing page numbers of the image denoted in FIG. 3, comprises by, way of example, the following operations. First, regions are created for each line of text in the image. FIG. 4 depicts a method for creating the regions for each line of text in the image. Referring to FIG. 4, the image is processed for each row at step 410. The term “row” in this context means a linear array of pixels placed side by side. Then, at step 412, pixel data in each row is classified into “dark” and “light” pixels by comparison with a threshold. For example, in an 8-bit grayscale image, pure black has code value 0 and pure white has code value 255. A simple technique that may be used is to compare the pixels to a value halfway between black and white (code value 128), for example. However, the method of applying this type of threshold is not limiting on the invention and any other suitable criteria can be applied to effect the comparison. After the pixels have been classified, leftmost and rightmost pixel columns that contain “dark” pixels are computed in steps 414 and 416, respectively. The processing of each row is continued at step 418.

As shown in steps 420 and 424, a comparison operation is performed to determine the start region and the end region for each row. In the event that the processed row is not devoid of “dark” pixels (step 420), the row is stored as the start of region in step 422. The comparison operation is continued at step 424, and in the event the processed row is devoid of “dark” pixels, the row is stored as the end of the region at step 426. At steps 428 and 430, a left most pixel column and a right most pixel column of all the rows in the region defined by the start row in step 422 and the end row in step 426 are computed, respectively. The term “column” in this context means a linear array of pixels placed one above another. The above processing steps are repeated until an end of the image is found at block 432. At the end of the process, the regions have been created for all the text present in the image.

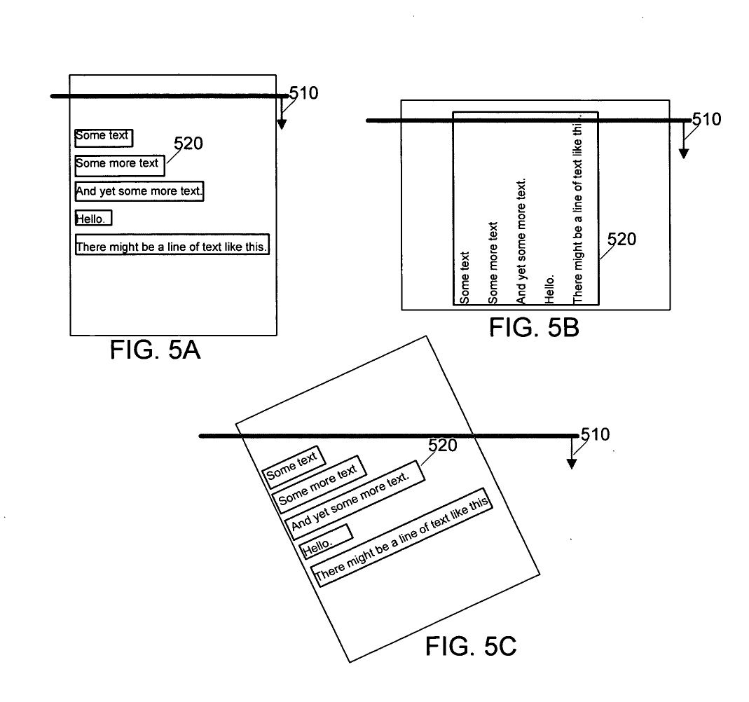

It should be noted that an orientation of a text can be determined before performing the steps described in FIG. 4. The orientation of the text may comprise, for example, portrait (FIG. 5A), landscape (FIG. 5B), and an arbitrary skew (FIG. 5C). The step 410 (FIG. 4) for processing each row is shown by the arrows 510 in these figures. Depending upon the text orientation, the height, width, and aspect ratio of the text regions 520 may vary as shown. A simple analysis to determine the orientation of the text is to examine the ratio of the width to the height of the text region 520. For a portrait orientation, the ratio of width to the height of the text region 520 is greater whereas for the landscape orientation the ratio of width to the height of the text region 520 is smaller. In case of the arbitrary skew, width content (number of “dark” and “light” pixels) for each text region is determined. If a substantial variation in the width content in upper or lower rows of the text region is present, then the orientation is determined to be the arbitrary skew.

Referring to the functions performed at the step 310 for detecting existing page numbers in the FIG. 3, after the regions are created for all the text present in the image, a second function is to examine all the regions and compute the likelihood that a region is a page number using the following criteria:
a width of the region of the page number is different as compared to a width of the main text regions. For example, a width of a text region is defined by the outer-most pixel columns with “dark” pixels, i.e., the minimum left margin of all the rows in the region, and the maximum right margin of all the rows in the region.
a height of the region of the page number is substantially the same as a height of the text regions. For example, a height of a region is defined by a contiguous set of image rows with some “dark” pixels.
a density of the region of the page number is substantially the same as a density of the text region. For example, a density of a region is defined by a number of “dark” and “light” pixels present in a region.
a position of the region of the page number is different compared to a position of the text region. The position of the region of the page number is examined in the following regions (commonly known as header and footer regions of a page).
   a) center at the bottom of the page,
   b) center at the top of the page,
   c) left or right bottom corners of the page, and
   d) left or right top corners of the page.

Thus, a page number is detected according to the embodiment, when a width of the region of the page number is different as compared to a width of the main text regions, a height of the region of the page number is essentially the same as a height of the text regions, a density of the region of the page number is essentially the same as a density of the text regions and a position of the region of the page number is different compared to a position of the text regions.

Further to the above analysis, a regions aspect size and ratio, frequency, and optical character recognition (OCR), etc., can also be used/examined to detect a page number. Accordingly, the above functions performed for detecting a page number are not limiting on the invention and any other suitable functions can also be used.

The step 320 of detecting a blank page of the image denoted in FIG. 3, comprises examining all of the regions that are created for each line of text for each “page” of the image using the method described in connection with FIG. 4 and computing that a page is blank if no text regions exist in the block of digital data that corresponds to that page.

Further, in order to achieve improved results in some embodiments for performing the copying functions, the image can be pre-processed before carrying out step 120 in FIG. 1. The pre-processing of the image may include removing any perimeter effects such as dark image borders that arise when copying/scanning a bound book. The dark image borders can be determined by creating a region for page surround. The page surround is a region that exists outside (top, bottom, left, and right) the text region of the image. The page surround region is determined if “dark” pixels are present throughout the entire length of the region outside the text region of the image (a threshold can be applied to determine the “dark” pixels in the page surround region similar to the step 412 in FIG. 4). If one or more page surround (top, bottom, left, or right) regions are present in the image then a decision is made to remove these regions. In a case, where the image itself comprises regions with “dark” pixels, then the decision is made not to remove the image regions that comprise “dark” pixels.

The steps 330 and 340 for detecting color of text and color of background of the image, respectively, as denoted in FIG. 3, comprise the following operations, according to an embodiment of the present invention. First, regions are located/detected for existing page numbers. Then, based on a threshold (for example), the page number region is classified into two categories; one is the text region and the other is the background region. Next, an average color is computed for the text region and the background region. The color of the text region and the color of the background region is computed separately in order to add a new page number. This will be discussed below.

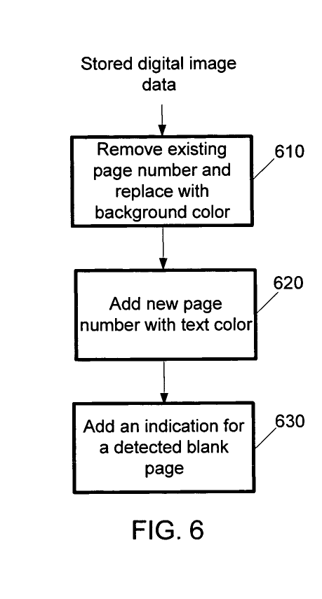

The image manipulation step at 140 in FIG. 1 is carried out based on the following functions as illustrated in FIG. 6, according to an embodiment of the present invention. First, an existing page number (which is detected earlier at step 310 in FIG. 3) is removed and replaced with the background color (which is detected at step 340 in FIG. 3) at step 610. Secondly, a new page number is added using text color (which is detected earlier at step 330 in FIG. 3) at step 620. The new page number is determined by counting consecutively from a first page of the input document. Finally, at step 630, adding an indication that the page is intentionally left blank, if a blank page is detected earlier at step 320 in FIG. 3.

In addition to the above functions, in one embodiment, a staple-bound document can also be created in the image manipulation step (140) in FIG. 1. The image is buffered until an appropriate modified digital image is generated (step 150 in FIG. 1) and the modified digital image is rotated depending upon a type of bound document desired to be printed. For example, if an eight page staple-bound document (duplex printing) is desired, pages 1, 2, 7, and 8 will be printed on a first sheet with pages 1 and 8 on one side and pages 2 and 7 on the other side. Similarly pages 3, 4, 5, and 6 will be printed on a second sheet with pages 3 and 5 on one side and pages 4 and 6 on the other side. When the printing is completed, the sheets are folded and stapled to bind the document.

The image analysis and image manipulation functions to be performed, according to an embodiment of the present invention, can be written in a machine readable language such as C. However, it should be noted that the present invention is not limited to the use of any given machine readable language and any other suitable language can also be used.

It should be noted that advantages realized in some embodiments wherein an automated method of copying is used instead of performing the tasks by hand include: ease of use, less tendency for error, and notably reduced collation or document preparation time.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention.

For example, while at least one embodiment is such that the page numbers are identified, removed and replaced with new ones, it is within the scope of the invention to provide an embodiment wherein the original numbers are not removed but are maintained and a new number added in supplement thereto. For example, an embodiment of the invention could be realized wherein the old numbers are identified such as through the use of strikethrough or presenting them or the new numbers in a different color. In this instance the image processing steps would be arranged to find a suitable location for the new page number.

A further embodiment is such that the source is slightly shrunk and a new page number is at the bottom, top or the like. The image processing step in this case is a simple reduction in size (which can accompany conventional copying) and reduces the burden on the intelligent image processing steps discussed above.

A further embodiment is such that automatic indexing or generation of a table of contents for the combined new document is enabled. In this connection OCR (Optical Character Reading) could be used to identify the titles of the separate documents and automatically list them in a manner which would result in a table of contents. As an alternative or supplement to the generation of this type of table of contents, another embodiment of the invention is such that user interaction either through the user panel of the copier or through a PC application is also possible.

As will be appreciated, the above-mentioned embodiments were chosen and described in order to explain the principles of the invention and its practical application, and thus enable one skilled in the art to utilize the invention in various embodiments and with various modifications as are suited to the particular use contemplated. The scope of the invention is limited only by the appended claims.

What is claimed is:

1. A method for copying documents, comprising:
creating input document image data for a plurality of input documents;
analyzing and manipulating the input document image data based on collation feature criteria; and
forming a coherent output document from analyzed and manipulated image data.

2. The method as set forth in claim 1, wherein the collation feature criteria comprises criteria for detecting existing page numbers in the input document image data.

3. The method as set forth in claim 1, wherein the collation feature criteria comprises criteria for detecting a blank page in the input document image data.

4. The method as set forth in claim 1, wherein the collation feature criteria comprises criteria for detecting text color and/or background color of the input document image data.

5. The method as set forth in claim 1, further comprising:
removing existing page numbers of the input document image data; and
creating the coherent output document with new consecutive page numbers.

6. The method as set forth in claim 1, further comprising:
creating the coherent output document with additional new consecutive page numbers; and
modifying existing page numbers of the input document image data so as to render them identifiable.

7. The method as set forth in claim 6, wherein the modifying comprises marking the existing page numbers with strike through.

8. The method as set forth in claim 6 wherein the modifying comprises making one of a color and a size of one of existing page numbers and the new consecutive page numbers, different.

9. The method as set forth in claim 1, further comprising detecting blank input pages in the input document image data and marking corresponding pages in the new document with an indication that the page is intentionally left blank.

10. The method as set forth in claim 1, further comprising rotating pages of the new document and placing staples to form a “staple-bound” output document.

11. The method as set forth in claim 1, further comprising preparing a table of contents by selecting data from the input document image data which corresponds to titles and arranging the data to form the table of contents.

12. A copying system, comprising:
an image acquisition mechanism for receiving a plurality of input documents;
an image analysis mechanism for analyzing image data of the input documents based upon collation feature criteria; and
an image manipulation mechanism for creating a coherent output document depending upon the output of the image analysis mechanism.

13. The copying system set forth in claim 12, wherein the collation feature criteria comprises criteria for detecting existing page numbers in the image data of the input documents.

14. The copying system set forth in claim 13, wherein the criteria for detecting existing page numbers of the input document image data comprise criteria for creating regions for each line of text and examining the regions to detect a page number.

15. The copying system set forth in claim 12, wherein the image analysis mechanism further comprises logic to detect blank pages in the input document image data.

16. The copying system set forth in claim 12, wherein the image analysis mechanism further comprises logic to detect text color and/or background color in the input document image data.

17. The copying system set forth in claim 12, wherein the image analysis mechanism further comprises:
logic to remove existing page numbers from the input document image data; and
logic to create a new document with new consecutive page numbers.

18. The copying system set forth in claim 12, wherein the image analysis mechanism further comprises:
logic for creating the coherent output document with additional new consecutive page numbers; and
logic for modifying existing page numbers of the input document image data so as to render them identifiable.

19. The copying system set forth in claim 18, wherein the logic for modifying existing page numbers comprises logic for marking the existing page numbers using strike through.

20. The copying system set forth in claim 18, wherein the logic for modifying existing page numbers comprises logic for making one of a color and a size of one of existing page numbers and the new consecutive page numbers, different.

21. The copying system set forth in claim 12, further comprising logic to mark detected blank input pages with an indication that the page is intentionally left blank.

22. The copying system set forth in claim 12, further comprising logic to rotate pages and place staples to form a “staple-bound” output document.

23. The copying system set forth in claim 12 further comprising logic preparing a table of contents by selecting data from the input document image data which corresponds to titles and arranging the data to form the table of contents.

24. A program product comprising machine readable program for causing a machine, when executed perform the following steps:
creating input document image data for a plurality of input documents; and
analyzing and manipulating the image data based on collation feature criteria and forming a coherent output document.

25. A program product comprising machine readable program for causing a machine, when executed to perform the following steps:
modifying existing page numbers from image data of a plurality of input documents; and
creating a new document with new page numbers.

26. A program product set forth in claim 25, wherein the step of modifying existing page numbers comprises one of removing the existing page number and marking the existing page numbers so that they are recognizable as being subservient to the new page numbers.

27. A program product set forth in claim 24, further comprising preparing a table of contents by selecting data from the input document image data which corresponds to titles and arranging the data to form the table of contents.

28. A program product set forth in claim 25, further comprising detecting blank input pages in the image data and marking detected blank input pages with an indication that the page is intentionally left blank.

29. The program product set forth in claim 25, further comprising a step for rotating pages and placing staples to form a “staple-bound” output document.

30. A copying system, comprising:
means for creating input document image data of a plurality of input documents; and
means for analyzing and manipulating the image data based on collation feature criteria to form a coherent document based on analyzed and manipulated image data.

31. The copying system as set forth in claim 30, further comprises:
means for removing existing page numbers from the input document image data; and
means for creating a new document with new page numbers.

32. The copying system as set forth in claim 30, further comprising:
means for creating the coherent output document with additional new consecutive page numbers; and
means for modifying existing page numbers of the input document image data so as to render them identifiable.

33. The method as set forth in claim 32, wherein the marking means marks the existing page numbers using strike through.

34. The method as set forth in claim 32 wherein the marking means makes one of a color and a size of one of existing page numbers and the new consecutive page numbers, different.

35. The method as set forth in claim 30, further comprising means for preparing a table of contents by selecting data from the input document image data which corresponds to titles and arranging the data to form the table of contents.

36. The system set forth in claim 30, further comprising means for detecting blank input pages in the input document image data and marking detected blank input pages with an indication that the page is intentionally left blank.

37. The system set forth in claim 30, further comprising means for rotating pages and placing staples to form a “staple-bound” output document.
